(19) United States
(12) Patent Application Publication
(10) Pub. No.: US 2025/0051543 A1
(43) Pub. Date: Feb. 13, 2025

(54) HIGH PERFORMANCE HYBRID FLUOROPOLYMER COMPOSITES MEMBRANES

(71) Applicants: SYENSQO SA, Brussels (BE); POLITECNICO DI TORINO, Torino (IT)

(72) Inventors: Julio A. Abusleme, Saronno (IT); Daniele Battegazzore, Alessandria (IT); Giulia Bernagozzi, Litta Parodi (IT); Alberto Frache, Alessandria (IT); Antonio Russo, Milano (IT)

(73) Assignees: SYENSQO SA, Brussels (BE); POLITECNICO DI TORINO, Torino (IT)

(21) Appl. No.: 18/718,258

(22) PCT Filed: Dec. 7, 2022
(86) PCT No.: PCT/EP2022/084810

§ 371 Date: Jun. 10, 2024

(30) Foreign Application Priority Data
Dec. 9, 2021 (EP) 21213289.8

(51) Int. Cl. C08K 5/11; B01D 71/34; C08F 214/22

(52) U.S. Cl. CPC C08K 5/11; B01D 71/34; C08F 214/225

(57) ABSTRACT

The invention pertains to a process for the manufacture of a fluoropolymer hybrid organic/inorganic composite, to a polymer electrolyte membrane based on a said fluoropolymer and to uses of said electrolyte membrane in various applications, especially in electrochemical applications.

### CROSS-REFERENCE TO RELATED APPLICATIONS

This application claims priority to European application No. 21213289.8 filed on Dec. 9, 2021, the whole content of this application being incorporated herein by reference for all purposes.

### TECHNICAL FIELD

The invention pertains to a process for the manufacture of a fluoropolymer hybrid organic/inorganic composite, to a polymer electrolyte membrane based on a said fluoropolymer and to uses of said electrolyte membrane in various applications, especially in electrochemical applications.

### BACKGROUND ART

Organic-inorganic polymer hybrids wherein inorganic solids on a nano or molecular level are dispersed in organic polymers have raised a great deal of scientific, technological and industrial interests because of their unique properties.

To elaborate organic-inorganic polymer hybrid composites, a sol-gel process using metal alkoxides is the most useful and important approach.

By properly controlling the reaction conditions of hydrolysis and polycondensation of metal alkoxides, in particular of alkoxysilanes (e.g. tetramethoxysilane (TMOS) or tetraethoxysilane (TEOS)), in the presence of pre-formed organic polymers, it is possible to obtain hybrids with improved properties compared to the original compounds. The polymer can enhance the toughness and processability of otherwise brittle inorganic materials, wherein the inorganic network can enhance scratch resistance, mechanical properties and surface characteristics of said hybrids.

Hybrids made from sol-gel technique starting from fluoropolymers, in particular from vinylidene fluoride polymers are known in the art.

For instance, WO 2013/160240 discloses the manufacture of a fluoropolymer hybrid organic/inorganic composite in the presence of a liquid medium, to provide a self-standing fluoropolymer film stably comprising and retaining said liquid medium and having outstanding ionic conductivity. The hybrid organic/inorganic composite may be obtained by a process comprising reacting the —OH functional groups of certain functionalized fluoropolymers with a silyl isocyanate and with an alkoxysilane in the presence of a liquid medium and of one electrolytic salt, followed by hydrolysis and/or polycondensation of said mixture. The resulting liquid mixture is then processed into a film by a solvent casting procedure, and dried to obtain the film. Said film can be used as polymer membranes suitable for use in electrochemical devices such as secondary batteries. The use of the silyl isocyanate is said to be essential in the processes where organic carbonates are used as liquid medium.

Unfortunately, because of the specific reactivity and reaction conditions, the process making use of isocyanates limits the choice of fluoropolymers to those comprising recurring units derived from monomers bearing hydroxyl functional groups.

Accordingly, the quest for a process to produce a fluoropolymer hybrid organic/inorganic composite that is suitable for preparing composites comprising different grades of fluoropolymers exists in this field.

It was unexpectedly demonstrated by the present inventors that a wide range of fluoropolymer hybrid organic/inorganic composites can be suitably prepared by a process according to the present invention, which makes use of certain versatile metal compounds as grafting agents, with the further advantage of obtaining composites having improved mechanical properties and flexibility.

### SUMMARY OF INVENTION

It is thus an object of the present invention a process for manufacturing a fluoropolymer hybrid organic/inorganic composite [polymer (F-h)], said process comprising the following steps:
(i) providing a composition [composition (C1)] containing a liquid medium [medium (L)] and at least one fluoropolymer [polymer (F)], wherein said polymer (F) comprises:
   recurring units derived from at least one fluorinated monomer [monomer (FM)], and
   recurring units derived from at least one monomer [monomer (FPM)], said monomer (FPM) comprising at least one functional group [group (FX)] selected from the group consisting of: hydroxyl group, amine, carboxylic, thiol and anhydride;
(ii) contacting composition (C1) with at least a first metal compound [compound (M1)] of formula (I):

X₄₋ₘAYₘ (I)

wherein m is an integer from 1 to 3, A is a metal selected from the group consisting of Si, Ti and Zr, each occurrence of Y is a hydrolysable group and each occurrence of X is a hydrocarbon group, wherein at least one X comprises at least one epoxy functional group,
so that at least a fraction of the group (FX) of monomer (FPM) of polymer (F) is reacted with at least a fraction of compound (M1), thereby providing a composition [composition (C2)] comprising at least one grafted fluoropolymer [polymer (F-j)] bearing -AYₘ pendant groups;
(iii) contacting composition (C2) with at least a second metal compound [compound (M2)], different from the compound (M1), of formula (II):

X′_{4-m′}A′Y′_{m′} (II)

wherein m′ is an integer from 1 to 4, A′ is a metal selected from the group consisting of Si, Ti and Zr, each occurrence of Y′ is a hydrolysable group and each occurrence of X′ is a hydrocarbon group, optionally comprising at least one functional group [group (FX′)], different from group (FX), so that at least a fraction of compound (M2) is reacted with at least a fraction of the -AYₘ pendant groups of polymer (F-j),
thereby providing a composition [composition (C3)] comprising at least one grafted fluoropolymer [polymer (F-g)] bearing -A′Y′ₘ pendant groups; and
(iv) hydrolysing and/or condensing the -A′Y′ₘ pendant groups of polymer (F-g) thereby providing a composition [composition (C4)] comprising at least one fluoropolymer hybrid organic/inorganic composite [polymer (F-h)].

A second object of the present invention pertains to the fluoropolymer hybrid organic/inorganic composite [polymer (F-h)] obtainable by the process of the invention.

The polymer (F-j) formed in step (ii) of the process of the present invention is novel and represents a further aspect of the present invention.

In another object, the present invention provides a fluoropolymer film comprising at least one fluoropolymer hybrid organic/inorganic composite [polymer (F-h)] according to the present invention.

Thus, the invention further pertains to a process for the manufacture of a fluoropolymer film comprising at least one fluoropolymer hybrid organic/inorganic composite [polymer (F-h)].

### DESCRIPTION OF EMBODIMENTS

The polymer (F) is typically obtainable by polymerization of at least one monomer (FM) and at least one monomer (FPM).

Monomer (FPM) can be selected from (per)fluorinated monomers and hydrogenated monomers comprising at least one functional group [group (FX)].

Suitable hydrogenated monomers (FPM) are monomers of formula (III):

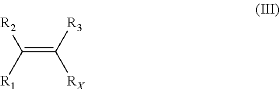

wherein:
R₁, R₂ and R₃, equal to or different from each other, are independently selected from a hydrogen atom and a C₁-C₃ hydrocarbon group, and
R_{X} is a C₁-C₂₀ hydrocarbon moiety comprising at least one functional group [group (FX)] selected from the group consisting of: hydroxyl group, amine, carboxylic acid group, thiol group and anhydride.

Rx may contain other functional groups different from group (FX) and may include heteroatoms.

By the term “fluorinated monomer [monomer (FM)]” it is hereby intended to denote an ethylenically unsaturated monomer comprising at least one fluorine atom.

The term “at least one fluorinated monomer” is understood to mean that the polymer (F) may comprise recurring units derived from one or more than one fluorinated monomers. In the rest of the text, the expression “fluorinated monomers” is understood, for the purposes of the present invention, both in the plural and the singular, that is to say that they denote both one or more than one fluorinated monomers as defined above.

Non limitative examples of suitable monomers (FM) include, notably, the followings:
C₂-C₈ perfluoroolefins, such as tetrafluoroethylene and hexafluoropropylene;
C₂-C₈ hydrogenated fluoroolefins, such as vinylidene fluoride, vinyl fluoride, 1,2-difluoroethylene and trifluoroethylene;
perfluoroalkylethylenes of formula CH₂═CH—R_{f0} wherein R_{f0} is a C₁-C₆ perfluoroalkyl;
chloro- and/or bromo- and/or iodo-C₂-C₆ fluoroolefins, such as chlorotrifluoroethylene;
(per)fluoroalkylvinylethers of formula CF₂═CFOR_{f1} wherein R_{f1} is a C₁-C₆ fluoro- or perfluoroalkyl, e.g. CF₃, C₂F₅, C₃F₇;
CF₂═CFOX₀ (per)fluoro-oxyalkylvinylethers wherein X₀ is a C₁-C₁₂ alkyl group, a C₁-C₁₂ oxyalkyl group or a C₁-C₁₂ (per)fluorooxyalkyl group having one or more ether groups, such as perfluoro-2-propoxy-propyl group;
(per)fluoroalkylvinylethers of formula CF₂═CFOCF₂OR_{f2} wherein R_{f2} is a C₁-C₆ fluoro- or perfluoroalkyl group, e.g. CF₃, C₂F₅, C₃F₇ or a C₁-C₆ (per)fluorooxyalkyl group having one or more ether groups, such as —C₂F₅—O—CF₃;
functional (per)fluoro-oxyalkylvinylethers of formula CF₂═CFOY₀ wherein Y₀ is a C₁-C₁₂ alkyl group or (per)fluoroalkyl group, a C₁-C₁₂ oxyalkyl group or a C₁-C₁₂ (per)fluorooxyalkyl group having one or more ether groups and Y₀ comprising a carboxylic or sulfonic acid group, in its acid, acid halide or salt form;
fluorodioxoles, preferably perfluorodioxoles.

Preferred polymers (F) are those comprising recurring units derived from at least one monomer (FM) selected from the group consisting of vinylidene fluoride (VDF), tetrafluoroethylene (TFE) and chlorotrifluoroethylene (CTFE).

The polymer (F) typically comprises from 0.02% by moles to 5.0% by moles of recurring units derived from at least one monomer [monomer (FPM)] of formula (III):

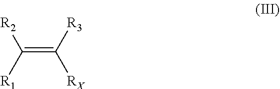

wherein:
R₁, R₂ and R₃, equal to or different from each other, are independently selected from a hydrogen atom and a C₁-C₃ hydrocarbon group, and
R_{X} is a C₁-C₂₀ hydrocarbon moiety comprising at least one functional group [group (FX)] selected from the group consisting of: hydroxyl group, amine, carboxylic group, thiol group and anhydride,
the aforementioned percentages by moles being referred to the total moles of recurring units of polymer (F).
Rx may contain other functional groups different from group (FX) and may include heteroatoms

The monomer (FPM) is notably selected from the group consisting of (meth)acryli c monomers of formula (IV):

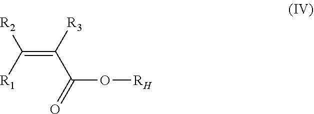

wherein R₁, R₂ and R₃, are as above defined, R_{H} is a hydrogen atom or a C₁-C₂₀ hydrocarbon moiety comprising at least one functional group [group (FX_{H})] selected from the group consisting of: hydroxyl group, amine, carboxylic group, thiol group and anhydride. More preferably, said functional group (FX_{H}) is selected from the group consisting of hydroxyl group and carboxylic group.

Non limitative examples of monomers (FPM) include, notably, hydroxyethyl(meth)acrylate, hydroxypropyl(meth)acrylate, hydroxyethylhexyl(meth)acrylate, acrylic acid (AA), and succinic acid 1-[2-(acryloyloxy)propyl] ester.

When the functional group (FX) in monomer (FPM) is an amine, it may be suitably selected from primary and secondary amines. Said amines may be both aliphatic and aromatic amines.

Determination of average mole percentage of monomer (FPM) recurring units in polymer (F) can be performed by any suitable method. Mention can be notably made of acid-base titration methods, well suited e.g. for the determination of the carboxylic groups content, of NMR methods, adequate for the quantification of monomers (FPM) comprising aliphatic hydrogen atoms in side chains, of weight balance based on total fed monomer (FPM) and unreacted residual monomer (FPM) during polymer (F) manufacture.

In certain preferred embodiments, monomer (FPM) is randomly distributed in polymer (F). In said embodiments, a fraction of at least 40% of monomer (FPM) is randomly distributed into said polymer (F).

The expression “randomly distributed in polymer (F)” is intended to denote the percent ratio between the average number of monomer (FPM) sequences (%), said sequences being comprised between two recurring units derived from monomer (FM), and the total average number of monomer (FPM) recurring units (%), according to the following formula:

$$Fraction of randomly distributed units ( FPM ) = \frac{average number of ( FPM ) sequences ( \% )}{average total number of ( FPM ) units ( \% )} \cdot 100$$

When each of the (FPM) recurring units is isolated, that is to say comprised between two recurring units of monomer (FM), the average number of (FPM) sequences equal the average total number of (FPM) recurring units, so the fraction of randomly distributed units (FPM) is 100%: this value corresponds to a perfectly random distribution of (FPM) recurring units.

Thus, the larger is the number of isolated (FPM) units with respect to the total number of (FPM) units, the higher will be the percentage value of fraction of randomly distributed units (FPM), as above described.

The polymer (F) may be amorphous or semi-crystalline.

The term “amorphous” is hereby intended to denote a polymer (F) having a heat of fusion of less than 5 J/g, preferably of less than 3 J/g, more preferably of less than 2 J/g, as measured according to ASTM D-3418-08.

The term “semi-crystalline” is hereby intended to denote a polymer (F) having a heat of fusion of from 10 to 90 J/g, preferably of from 30 to 60 J/g, more preferably of from 35 to 55 J/g, as measured according to ASTM D3418-08.

The polymer (F) is preferably semi-crystalline.

Preferably, the intrinsic viscosity of polymer (F), measured in dimethylformamide at 25° C., is comprised between 0.05 l/g and 0.80 l/g, more preferably between 0.10 l/g and 0.50 l/g even more preferably between 0.2 l/g and 0.4 l/g.

Preferred polymers (F) are those comprising one or more backbone chains, said backbone chains comprising recurring units derived from at least one monomer (FM) selected from the group consisting of vinylidene fluoride (VDF), tetrafluoroethylene (TFE) and chlorotrifluoroethylene (CTFE).

The polymer (F) preferably comprises recurring units derived from vinylidene fluoride (VDF), at least one monomer (FPM) as defined above and, optionally, at least one further monomer (FM) different from VDF. The further monomer (FM) in polymer (F) is preferably HFP.

The polymer (F) preferably comprises:
(a) at least 60% by moles, preferably at least 75% by moles, more preferably at least 85% by moles of vinylidene fluoride (VDF);
(b) optionally, from 0.1% to 15% by moles, preferably from 0.5% to 10% by moles, more preferably from 1% to 5% by moles of at least one monomer (FM) selected from vinyl fluoride (VF1), chlorotrifluoroethylene (CTFE), hexafluoropropylene (HFP), tetrafluoroethylene (TFE), trifluoroethylene (TrFE), perfluoromethylvinylether (PMVE); and
(c) from 0.01% to 10% by moles, preferably from 0.05% to 5% by moles, more preferably from 0.1% to 2% by moles of at least one monomer (FPM) of formula (III) as defined above.

The polymer (F) is typically obtainable by emulsion polymerization or suspension polymerization.

In a particularly preferred embodiment, polymer (F) used in the process of the present invention comprises:
(a) at least 60% by moles, preferably at least 75% by moles, more preferably at least 85% by moles of vinylidene fluoride (VDF);
(b) optionally, from 0.1% to 15% by moles, preferably from 0.5% to 10% by moles, more preferably from 1% to 5% by moles of at least one monomer (FM) selected from vinyl fluoride (VF1), chlorotrifluoroethylene (CTFE), hexafluoropropylene (HFP), tetrafluoroethylene (TFE), trifluoroethylene (TrFE), perfluoromethylvinylether (PMVE); and
(c) from 0.01% to 10% by moles, preferably from 0.05% to 5% by moles, more preferably from 0.1% to 2% by moles of acrylic acid (AA), said polymer (F) having intrinsic viscosity, measured in dimethylformamide at 25° C., that is comprised between 0.2 l/g and 0.4 l/g.

For the purpose of the present invention, by the term “liquid medium [medium (L)]” it is hereby intended to denote a composition comprising one or more substances in the liquid state at 20° C. under atmospheric pressure.

According to some embodiments of the present invention, said medium (L) is preferably selected from organic carbonates, ionic liquids (IL), solvents (S), or mixtures thereof.

Within the present invention, solvent(S) is intended to denote a solvent suitable for dissolving polymer (F) as defined above. To this aim, solvent(S) is typically selected from the group consisting of: N-methyl-2-pyrrolidone (NMP), N,N-dimethylformamide, N,N-dimethylacetamide, dimethylsulfoxide, hexamethylphosphamide, dioxane, tetrahydrofuran, tetramethylurea, triethyl phosphate, and trimethyl phosphate, aliphatic ketones, cycloaliphatic ketones, cycloaliphatic esters. These solvents may be used singly or in mixture of two or more species.

According to a first embodiment of the invention, said medium (L) comprises at least one organic carbonate as the only medium (L).

Non-limiting examples of suitable organic carbonates include, notably, ethylene carbonate, propylene carbonate, mixtures of ethylene carbonate and propylene carbonate, dimethyl carbonate, diethyl carbonate, ethyl-methyl carbonate, butylene carbonate, vinylene carbonate, fluoroethylene carbonate, fluoropropylene carbonate and mixtures thereof.

According to a second embodiment of the invention, said medium (L) comprises at least one ionic liquid (IL) as the only medium (L).

By the term “ionic liquid (IL)”, it is hereby intended to denote a compound formed by the combination of positively charged cations and negatively charged anions which exists in the liquid state at temperatures below 100° C. under atmospheric pressure.

The ionic liquid (IL) can be selected from protic ionic liquids (ILₚ), aprotic ionic liquids (ILₐ) and mixtures thereof.

By the term “protic ionic liquid (ILₚ)”, it is hereby intended to denote an ionic liquid wherein the cation comprises one or more H⁺ hydrogen ions.

Non-limitative examples of cations comprising one or more H⁺ hydrogen ions include, notably, imidazolium, pyridinium, pyrrolidinium or piperidinium rings, wherein the nitrogen atom carrying the positive charge is bound to a H⁺ hydrogen ion.

By the term “aprotic ionic liquid (ILₐ)”, it is hereby intended to denote an ionic liquid wherein the cation is free of H⁺ hydrogen ions.

The ionic liquid (IL) is typically selected from those comprising as cation a sulfonium ion or an imidazolium, pyridinium, pyrrolidinium or piperidinium ring, said ring being optionally substituted on the nitrogen atom, in particular by one or more alkyl groups with 1 to 8 carbon atoms, and on the carbon atoms, in particular by one or more alkyl groups with 1 to 30 carbon atoms.

According to another embodiment of the invention, said medium (L) comprises a mixture of at least one organic carbonate as defined above and at least one ionic liquid (IL) as defined above.

According to further embodiment of the invention, said medium (L) comprises a mixture of at least one organic solvent and at least one organic carbonate as defined above and/or at least one ionic liquid (IL) as defined above. Liquid medium (L) according to this embodiment will be herein after referred to as “medium (LS)”.

The medium (L) in composition (C1) may further comprise at least one metal salt(S). By the term “metal salt(S)”, it is hereby intended to denote a metal salt comprising electrically conductive ions.

A variety of metal salts may be employed as metal salts(S). Metal salts which are stable and soluble in the chosen liquid medium (L) are generally used.

Non-limitative examples of suitable metal salts(S) include, notably, MeI, Me(PF₆)ₙ, Me(BF₄)ₙ, Me(ClO₄)ₙ, Me(bis(oxalato)borate)ₙ (“Me(BOB)ₙ”), MeCF₃SO₃, Me[N(CF₃SO₂)₂]ₙ, Me[N(C₂F₅SO₂)₂]ₙ, Me[N(CF₃SO₂)(R_{F}SO₂)]ₙ with R_{F} being C₂F₅, C₄F₉, CF₃OCF₂CF₂, Me(AsF₆)ₙ, Me[C(CF₃SO₂)₃]ₙ, Me₂Sₙ, wherein Me is a metal, preferably a transition metal, an alkaline metal or an alkaline-earth metal, more preferably Me being Li, Na, K, Cs, and n is the valence of said metal, typically n being 1 or 2.

Preferred metal salts(S) are selected from the followings: LiI, LiPF₆, LiBF₄, LiClO₄, lithium bis(oxalato)borate (“LiBOB”), LiCF₃SO₃, LiN(CF₃SO₂)₂ (“LiTFSI”), LiN(C₂F₅SO₂)₂, M[N(CF₃SO₂)(R_{F}SO₂)]ₙ with R_{F} being C₂F₅, C₄F₉, CF₃OCF₂CF₂, LiAsF₆, LiC(CF₃SO₂)₃, Li₂Sₙ and combinations thereof.

The medium (L) in composition (C1) may further comprise one or more additives.

Should one or more additives be present in the liquid medium, non-limitative examples of suitable additives include, notably, those which are soluble in the liquid medium.

The concentration of polymer (F) in the medium (L) of composition (C1) is advantageously lower than 40%, more preferably lower than 20% by weight.

In step (ii) of the process of the present invention composition (C1) is contacted with at least a first metal compound [compound (M1)] of formula (I): X₄₋ₘAYₘ (I)
wherein m is an integer from 1 to 3, A is a metal selected from the group consisting of Si, Ti and Zr, each occurrence of Y is a hydrolysable group and each occurrence of X is a hydrocarbon group, wherein at least one X comprises at least one epoxy functional group.

The polymer (F) and the metal compound (M1) are reacted at temperatures typically comprised between 20° C. and 250° C.

The skilled in the art will properly select the temperature depending on the boiling point of the medium (L), the equipment and the technique used for the reactions in the process.

Under step (ii) of the process of the invention, the composition (C1) advantageously further comprises at least one catalyst.

The catalyst for the grafting reaction of polymer (F) with metal compound (M1) is preferably selected from the group consisting of organic aluminium compounds such as aluminum trifluoromethanesulfonate.

In general, the molar amount of compound (M1) added in step (ii) corresponds to the molar amount of monomer (FPM) present in the composition (C1).

Under step (ii) of the process of the invention, the catalyst is typically added to the composition (C1) in an amount comprised between 0.1% and 50% by moles, preferably between 0.3% and 20% by moles, more preferably between 0.5% and 10% by moles, based on the total amount by moles of compound (M1).

Under step (ii) at least a fraction of the group (FX) of monomer (FPM) of polymer (F) is reacted with at least a fraction of compound (M1), thereby providing a composition [composition (C2)] comprising at least one grafted fluoropolymer [polymer (F-j)] bearing -AYₘ pendant groups.

Under step (iii) of the process, composition (C2) obtained in step (ii) is contacted with a metal compound (M2).

Compound (M2), different from compound (M1), is a compound of formula (II):

X′_{4-m′}A′Y′_{m′} (II)
wherein m′ is an integer from 1 to 4, A′ is a metal selected from the group consisting of Si, Ti and Zr, each occurrence of Y′ is a hydrolysable group and each occurrence of X′ is a hydrocarbon group, optionally comprising at least one functional group [group (FX′)], different from group (FX) of monomer (FPM).

Non limitative examples of functional group (FX′) include, notably, carboxylic acid group (in its acid, ester, amide, anhydride, salt or halide form), sulphonic group (in its acid, ester, salt or halide form), hydroxyl group, phosphoric acid group (in its acid, ester, salt, or halide form), thiol group, amine group, quaternary ammonium group, ethylenically unsaturated group (like vinyl group), cyano group, urea group, organo-silane group, aromatic group.

Preferably, X′ in metal compound (M2) is selected from C₁-C₁₈ hydrocarbon groups, optionally comprising one or more functional groups. More preferably, X′ in metal compound (M2) is a C₁-C₁₂ hydrocarbon group, optionally comprising one or more functional group.

The selection of the hydrolysable group Y′ of the metal compound of formula (I) is not particularly limited, provided that it enables in appropriate conditions the formation of a —O-A′≡ bond; said hydrolysable group can be notably a halogen (especially a chlorine atom), a hydrocarboxy group, a acyloxy group or a hydroxyl group.

Examples of functional metal compound (M2) are notably vinyltriethoxysilane, vinyltrimethoxysilane, vinyltrismethoxyethoxysilane of formula CH₂═CHSi(OC₂H₄OCH₃)₃, 2-(3,4-epoxycyclohexylethyltrimethoxysilane) of formula:

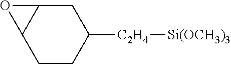

glycidoxypropylmethyldiethoxysilane of formula:

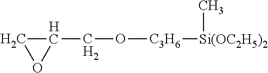

glycidoxypropyltrimethoxysilane of formula:

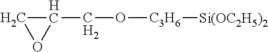

methacryloxypropyltrimethoxysilane of formula:

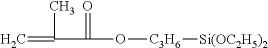

aminoethylaminpropylmethyldimethoxysilane of formula:

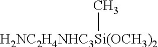

aminoethylaminpropyltrimethoxysilane of formula:

H₂NC₂H₄NHC₃H₆Si(OCH₃)₃

3-aminopropyltriethoxysilane, 3-phenylaminopropyltrimethoxysilane, 3-chloroisobutyltriethoxysilane, 3-chloropropyltrimethoxysilane, 3-mercaptopropyltriethoxysilane, 3-mercaptopropyltrimethoxysilane, n-(3-acryloxy-2-hydroxypropyl)-3-aminopropyltriethoxysilane, (3-acryloxypropyl)dimethylmethoxysilane, (3-acryloxypropyl)methyldichlorosilane, (3-acryloxypropyl)methyldimethoxysilane, 3-(n-allylamino) propyltrimethoxysilane, 2-(4-chlorosulfonylphenyl)ethy ltrimethoxysilane, 2-(4-chlorosulphonylphenyl)ethy l trichlorosilane, carboxyethylsilanetriol, and its sodium salts, triethoxysilylpropylmaleamic acid of formula:

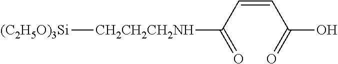

3-(trihydroxysilyl)-1-propane-sulphonic acid of formula HOSO₂—CH₂CH₂CH₂—Si(OH)₃, N-(trimethoxysilylpropyl)ethylene-diamine triacetic acid, and its sodium salts, 3-(triethoxysilyl) propylsuccinic anhydride of formula:

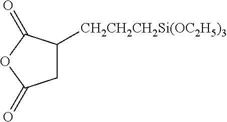

acetamidopropyltrimethoxysilane of formula H₃C—C(O)NH—CH₂CH₂CH₂—Si(OCH₃)₃, alkanolamine titanates of formula Ti(A)_{X}(OR)_{Y}, wherein A is an amine-substituted alkoxy group, e.g. OCH₂CH₂NH₂, R is an alkyl group, and x and y are integers such that x+y=4.

Examples of non-functional metal compound (M2) are notably triethoxysilane, trimethoxysilane, tetramethyltitanate, tetraethyltitanate, tetra-n-propyltitanate, tetraisopropyltitanate, tetra-n-butyltitanate, tetra-isobutyl titanate, tetra-tert-butyl titanate, tetra-n-pentyltitanate, tetra-n-hexyltitanate, tetraisooctyltitanate, tetra-n-lauryl titanate, tetraethylzirconate, tetra-n-propylzirconate, tetraisopropylzirconate, tetra-n-butyl zirconate, tetra-sec-butyl zirconate, tetra-tert-butyl zirconate, tetra-n-pentyl zirconate, tetra-tert-pentyl zirconate, tetra-tert-hexyl zirconate, tetra-n-heptyl zirconate, tetra-n-octyl zirconate, tetra-n-stearyl zirconate.

The amount of compound (M2) added in step (iii) of the process is in general comprised from 1% and 90% by weight, with reference to the total weight of monomer (M1) and polymer (F).

Compound (M2) may suitably be added to the reaction mixture obtained in step (ii) in the form of solid compound or, alternatively, in an admixture with an aqueous medium (A), possibly including an acid catalyst as defined below.

By the term “aqueous medium”, it is hereby intended to denote a liquid medium comprising water that is in the liquid state at 20° C. under atmospheric pressure.

The aqueous medium (A) more preferably consists of water and one or more alcohols. The alcohol included in medium (A) is preferably ethanol.

Step (iii) may be carried out in the same equipment used for step (ii), at the same conditions of temperature and concentration.

All the details described above for the process conditions of step (ii) can be applied here for defining step (iii).

In step (iii), at least a fraction of compound (M2) reacts with at least a fraction of the -AYₘ pendant groups of polymer (F-j),
thereby providing a composition [composition (C3)] comprising at least one grafted fluoropolymer [polymer (F-g)] bearing -A′Y′ₘ pendant groups.

Compound (M2) may further react with residual fraction of the group (FX) of monomer (FPM) of polymer (F).

The possible reactivity of compound (M2) with any residual fraction of the group (FX) of monomer (FPM) of polymer (F) depends on the reaction conditions and the liquid medium used in the previous steps.

In step (iv) of the process of the invention, the pendant groups -A′Y′m of polymer (F-g) undergo to hydrolysis and/or condensation, thereby providing a composition [composition (C4)] comprising at least one fluoropolymer hybrid organic/inorganic composite [polymer (F-h)] comprising fluoropolymer domains and inorganic domains.

It is understood that the hydrolysis and/or condensation reaction of step (iv) may initiate in the reaction system already during step (ii) of the process of the invention, and may be continued during any one of steps (iii) and (iv) of the process of the invention.

As this will be recognized by the skilled in the art, the hydrolysis and/or condensation usually generates low molecular weight side products, which can be notably water or alcohols, as a function of the nature of the compound (M1) and, optionally, of the compound (M2).

An acid catalyst is typically added to the composition of any one of steps (iii) or (iv) of the process of the invention.

The selection of the acid catalyst is not particularly limited. The acid catalyst is typically selected from the group consisting of organic and inorganic acids.

The acid catalyst is typically added to the composition of any one of steps (iii) or (iv) of the process of the invention in an amount comprised between 0.01% and 100% by weight, preferably between 0.5% and 60% by weight, based on the total weight of compound (M2).

The acid catalyst is preferably selected from the group consisting of organic acids such as citric acid, acetic acid and formic acid.

Very good results have been obtained with formic acid and citric acid.

In one embodiment of the invention, step (ii) and step (iii) are carried out simultaneously.

By the term “carried out simultaneously” it is intended that metal compound (M1) and metal compound (M2) are added together to composition (C1).

Without being bound by this theory, the Applicant believes that in the reaction conditions the group (FX) of monomer (FPM) of polymer (F) first reacts with metal compound (M1) thus providing at least one grafted fluoropolymer [polymer (F-j)] bearing -AYₘ pendant groups; then, at least a fraction of compound (M2) reacts with at least a fraction of the -AYₘ pendant groups of polymer (F-j), thereby providing a composition [composition (C4)] comprising at least one grafted fluoropolymer [polymer (F-g)] bearing -A′Y′m pendant groups.

According to another embodiment of the invention, step (ii) and step (iii) are carried out sequentially.

According to said embodiment of the invention, polymer (F-j) can be isolated from composition (C2) after step (ii). In this embodiment, the [composition (C2)] comprising at least one grafted fluoropolymer [polymer (F-j)] bearing -AYₘ pendant groups obtained at the end of step (ii) can be further submitted to step (iib):
(iib) isolating the fluoropolymer [polymer (F-j)] as solid by filtration of composition (C2), washing the solid with polar solvents and drying to recover dry polymer (F-j).

The polar solvent used in the washing is suitably selected from solvents that are not able to solubilize the polymer (F-j). The polar solvent may typically be selected from alcohols.

Under step (iib) of the process of the invention, the polymer (F-j) after filtration and washing is dried at a temperature typically comprised between 25° C. and 200° C.

Drying can be performed either under atmospheric pressure or under vacuum. Alternatively, drying can be performed under modified atmosphere, e.g. under an inert gas, typically exempt notably from moisture (water vapour content of less than 0.001% v/v).

Polymer (F-j) formed during the process, being an intermediate in the process for preparing said polymer (F-h), is novel and represents a further aspects of the present invention.

Thus, in one aspect, the present invention provides a grafted fluoropolymer [polymer (F-j)], obtainable by a process comprising the following steps:
(i) providing a composition [composition (C1)] containing a liquid medium [medium (L)] and at least one fluoropolymer [polymer (F)], wherein said polymer (F) comprises:
   recurring units derived from at least one fluorinated monomer [monomer (FM)], and
   recurring units derived from at least one monomer [monomer (FPM)], said monomer (FPM) comprising at least one functional group [group (FX)] selected from the group consisting of: hydroxyl group, amine, carboxylic, thiol and anhydride;
(ii) contacting composition (C1) with at least a first metal compound [compound (M1)] of formula (I):

X₄₋ₘAYₘ (I)

wherein m is an integer from 1 to 3, A is a metal selected from the group consisting of Si, Ti and Zr, each occurrence of Y is a hydrolysable group and each occurrence of X is a hydrocarbon group, wherein at least one X comprises at least one epoxy functional group,
so that at least a fraction of the group (FX) of monomer (FPM) of polymer (F) is reacted with at least a fraction of compound (M1), thereby providing a composition [composition (C2)] comprising at least one grafted fluoropolymer [polymer (F-j)] bearing -AYₘ pendant groups; and
(iib) isolating the fluoropolymer [polymer (F-j)] as solid by filtration of composition (C2), washing the solid with polar solvents and drying to recover dry polymer (F-j).

Polymer (F-j) obtained in step (iib) of the process of the present invention can further be grinded and isolated as a powder ingredient for subsequent use.

According to a first variant [variant (A)] of the process for the manufacture of a fluoropolymer hybrid organic/inorganic composite [polymer (F-g)], the medium (L) in composition (C1) is medium (LS) as above defined.

Consequently, composition (C4) obtained at the end of step (iv) of variant (A) comprises polymer (F-g), at least one organic solvent(S).

According to a second variant [variant (B)] of the process for the manufacture of a fluoropolymer hybrid organic/inorganic composite [polymer (F-g)], the medium (L) in composition (C1) provided in step i) does not comprise any solvent(S) as above defined.

Consequently, composition (C4) obtained at the end of step (iv) of variant (B) comprises polymer (F-g) and a liquid medium (L) with no organic solvent(S).

In another object, the present invention provides a fluoropolymer film comprising at least one fluoropolymer hybrid organic/inorganic composite [polymer (F-h)] according to the present invention.

Thus, the invention further pertains to a process for the manufacture of a fluoropolymer film comprising at least one fluoropolymer hybrid organic/inorganic composite [polymer (F-h)], said process comprising the following steps:
(i) providing a composition [composition (C1)] containing a liquid medium [medium (L)] and at least one fluoropolymer [polymer (F)], wherein said polymer (F) comprises:
   recurring units derived from at least one fluorinated monomer [monomer (FM)], and
   recurring units derived from at least one monomer [monomer (FPM)], said monomer (FPM) comprising at least one functional group [group (FX)] selected from the group consisting of: hydroxyl group, amine, carboxylic, thiol and anhydride; and
(ii) contacting composition (C1) with at least a first metal compound [compound (M1)] of formula (I):

X₄₋ₘAYₘ (I)

wherein m is an integer from 1 to 3, A is a metal selected from the group consisting of Si, Ti and Zr, each occurrence of Y is a hydrolysable group and each occurrence of X is a hydrocarbon group, wherein at least one X comprises at least one epoxy functional group,
so that at least a fraction of the group (FX) of monomer (FPM) of polymer (F) is reacted with at least a fraction of compound (M1), thereby providing a composition [composition (C2)] comprising at least one grafted fluoropolymer [polymer (F-j)] bearing -AYₘ pendant groups; and
(iii) contacting composition (C2) with at least a second metal compound [compound (M2)], different from the compound (M1), of formula (II):

X′_{4-m′}A′Y′_{m′} (II)

wherein m′ is an integer from 1 to 4, A′ is a metal selected from the group consisting of Si, Ti and Zr, each occurrence of Y′ is a hydrolysable group and each occurrence of X′ is a hydrocarbon group, optionally comprising at least one functional group [group (FX′)], different from group (FX), so that at least a fraction of compound (M2) is reacted with at least a fraction of the -AYₘ pendant groups of polymer (F-j),
thereby providing a composition [composition (C3)] comprising at least one grafted fluoropolymer [polymer (F-g)] bearing -A′Y′ₘ pendant groups; and
(iv) hydrolysing and/or condensing the -A′Y′ₘ pendant groups of polymer (F-g) thereby providing a composition [composition (C4)] comprising at least one fluoropolymer hybrid organic/inorganic composite [polymer (F-h)].
(v) processing composition (C4) comprising at least one fluoropolymer hybrid organic/inorganic composite [polymer (F-h)], as defined above, into a film; and
(vi) drying the film provided in step v).

For the purpose of the present invention, the term “film” is intended to denote a continuous, generally thin, sheet.

When the process for obtaining polymer (F-h) is carried out according to variant (A) as above defined, composition (C4) obtained at the end of step (iv) contains at least one organic solvent(S), and said composition (C4) is suitable for being casted with any standard casting method to produce a thin film.

Therefore, when composition (C4) is obtained according to variant (A) processing said composition (C4) in step (v) into a film is typically carried out using techniques commonly known in the art.

Non-limitative examples of suitable techniques include casting, doctor blade coating, metering rod (or Meyer rod) coating, slot die coating, knife over roll coating or “gap” coating, and the like.

According to variant (A) of the process of the invention, under step (vi) the film provided in step (v) is dried at a temperature typically comprised between 25° C. and 200° C.

Drying can be performed either under atmospheric pressure or under vacuum. Alternatively, drying can be performed under modified atmosphere, e.g. under an inert gas, typically exempt notably from moisture (water vapour content of less than 0.001% v/v).

The drying temperature will be selected so as to effect removal by evaporation of solvent(S) in the medium (L) from the provided in step (iv) of the process of the invention.

When the process for obtaining polymer (F-h) is carried out according to variant (B) as above defined, composition (C4) obtained at the end of step (iv) does not contain any solvent(S).

According to said variant (B), steps (i) to (iv) of the process of the invention can be suitably carried out in a closed device, such as a reactor or in a semi-closed device, such as an extruder. In both said cases, the reactions in steps (i) to (iv) are carried out at high temperature in the presence of polymer (F) in the molten state, dissolved in liquid medium (L).

The residence time in said closed device depends on the equipment used and also on the reactivity of the system. The skilled in the art will select the proper timing for completing the reactions. The advantage of a closed device is that the residence time can be chosen from minutes to several hours or days. In a semi-closed device like an extruder this is not possible. In the examples below this case is exemplified.

When steps (i) to (iv) are performed in a semi closed device like an extruder the time of the reaction shall be adapted to the device architecture and rpm. The residence time in in a semi closed device like an extruder is typically lower than 10 minutes, preferably lower than 5 minutes.

According to said variant (B), when steps (i) to (iv) are carried out in a closed device, the composition (C4) can be processed into a film in step (v) by compression moulding or in an extruder. In both cases the composition (C4) discharged from the closed device at the end of step (iv) is preferably ground before being submitted to step (v).

According to variant (B), when steps (i) to (iv) are carried out in a semi closed device, steps (v) and step (vi) can be carried out in the same equipment, thus the film can be obtained directly from the die of the extruder. Alternatively, the material exiting the semi-closed device can be fed into a second extruder, specifically designed for obtaining fine films or polymer electrolyte membranes.

In the process for preparing films of fluoropolymer hybrid organic/inorganic composite [polymer (F-h)] a further step of colamination of the film obtained after step (v) or (vi) according to any of the above define variants can be applied to reduce the thickness of the film.

The film of fluoropolymer hybrid organic/inorganic composite [polymer (F-h)] preferably has a thickness in the range from 5 to 300 microns, preferably from 10 to 50 microns.

In the process for preparing films of fluoropolymer hybrid organic/inorganic composite [polymer (F-h)] a further post-treatment step of the film obtained after step (vi) or, optionally, after colamination, can be applied to complete the crosslinking that normally has already started in the previous steps of the process. Said crosslinking post-treatment comprises contacting said film with an acid catalyst as above defined. Contacting the film with the acid catalyst may be suitably carried out in an acid catalyst-saturated atmosphere for a time sufficient to complete the crosslinking.

Alternatively, the crosslinking post-treatment can comprise a heating treatment under pressure, such as at a temperature in the range of from at 80° C. to 120° C., for 2-10 minutes under a pressure of about 8 to 12 MPa. The post-treatment can be carried out also in hot calenders reducing or not the thickness of the film.

In a further alternative, the crosslinking post-treatment can be obtained by exposing the film to microwave radiations.

Under step (i) of the process of the invention, the composition (C1) may further comprise an electrolyte medium comprising at least one metal salt [medium (E)].

When in the process for preparing a film according to the present invention the medium (E) is present in composition (C1), then the film obtained by the process as above define is suitable for preparing a polymer electrolyte membrane. Composition (C1) according to this embodiment will be herein after referred to as “composition (C5)”.

In another aspect, thus, the present invention pertains to the polymer electrolyte membrane obtainable by the process of the invention.

For the purpose of the present invention, the term “membrane” is intended to denote a discrete, generally thin, interface which moderates permeation of chemical species in contact with it.

Thus, in one aspect, the present invention provides a process for manufacturing a polymer electrolyte membrane, said process comprising:
(i) providing a composition [composition (C5)] containing a liquid medium [medium (L)] and at least one fluoropolymer [polymer (F)], wherein said polymer (F) comprises:
   recurring units derived from at least one fluorinated monomer [monomer (FM)], and
   recurring units derived from at least one monomer [monomer (FPM)], said monomer (FPM) comprising at least one functional group [group (FX)] selected from the group consisting of: hydroxyl group, amine, carboxylic, thiol and anhydride,
   wherein the liquid medium (L) also comprises at least one metal salt (S); and
(ii) contacting composition (C5) with at least a first metal compound [compound (M1)] of formula (I):

X₄₋ₘAYₘ (I)

wherein m is an integer from 1 to 3, A is a metal selected from the group consisting of Si, Ti and Zr, each occurrence of Y is a hydrolysable group and each occurrence of X is a hydrocarbon group, wherein at least one X comprises at least one epoxy functional group,
so that at least a fraction of the group (FX) of monomer (FPM) of polymer (F) is reacted with at least a fraction of compound (M1), thereby providing a composition [composition (C2′)] comprising at least one grafted fluoropolymer [polymer (F-j)] bearing -AYₘ pendant groups; and
(iii) contacting composition (C2′) with at least a second metal compound [compound (M2)], different from the compound (M1), of formula (II):

X′_{4-m′}A′Y′_{m′} (II)

wherein m′ is an integer from 1 to 4, A′ is a metal selected from the group consisting of Si, Ti and Zr, each occurrence of Y′ is a hydrolysable group and each occurrence of X′ is a hydrocarbon group, optionally comprising at least one functional group [group (FX′)], different from group (FX), so that at least a fraction of compound (M2) is reacted with at least a fraction of the -AYₘ pendant groups of polymer (F-j),)
thereby providing a composition [composition (C3′)] comprising at least one grafted fluoropolymer [polymer (F-g)] bearing -A′Y′ₘ pendant groups;
(iv) hydrolysing and/or condensing the -A′Y′ₘ pendant groups of polymer (F-g) thereby providing a composition [composition (C4′)] comprising at least one fluoropolymer hybrid organic/inorganic composite [polymer (F-h)];
(v) processing composition (C4′) into a film; and
(vi) drying the film provided in step (v).

All the details and features described above for the process for preparing a film of fluoropolymer hybrid organic/inorganic composite [polymer (F-h) can be applied here for defining the process for preparing the polymer electrolyte membrane of the invention.

The polymer electrolyte membrane of the present invention is advantageously endowed with outstanding crosslinking density properties and thus successfully exhibits outstanding mechanical properties to be suitably used as a free-standing polymer electrolyte membrane.

Determination of the crosslinking density of the fluoropolymer hybrid organic/inorganic composite of the present invention can be performed by any suitable method. The fluoropolymer hybrid organic/inorganic composite is typically swelled in a suitable solvent at a specific temperature and either the change in mass or the change in volume is measured.

It has been surprisingly found that the free-standing polymer electrolyte membrane of the present invention can stably comprise and retain high fractions of electrolytes while maintaining outstanding mechanical properties and excellent ionic conductivity properties.

In a further aspect, the present invention pertains to an electrochemical device comprising the polymer electrolyte membrane of the invention.

Non-limitative examples of suitable electrochemical devices include, notably, secondary batteries, especially, alkaline or an alkaline-earth secondary batteries such as Lithium ion batteries, and capacitors, especially Lithium ion capacitors.

Should the disclosure of any patents, patent applications, and publications which are incorporated herein by reference conflict with the description of the present application to the extent that it may render a term unclear, the present description shall take precedence.

The invention will be now described in more detail with reference to the following examples whose purpose is merely illustrative and not limitative of the scope of the invention.

### EXPERIMENTAL SECTION

### Raw Materials

Polymer (F-1): VDF/HEA (0.4% by moles)/HFP (2.5% by moles) copolymer having an intrinsic viscosity of 0.11 l/g in DMF at 25° C.

Polymer (F-2): VDF-AA (0.9% by moles)-HFP (2.4% by moles) polymer having a viscosity of 0.30 l/g in DMF at 25° C.

Epoxy silane (EPP-1): [3-(2,3-epoxypropoxy) propyl] trimethoxysilane.

Epoxy silane (EPP-2): [3-(2,3-epoxypropoxy) propyl] triethoxysilane. Catalyst (ATS): Aluminum trifluoromethanesulfonate.

LiTFSI: bis(trifluoromethanesulfonyl)imi de lithium salt.

Medium (EL-1): ethylene carbonate (EC)/propylene carbonate (PC) (1/1 by weight).

Medium (EL-2): solution of LiTFSI (1 mol/L) in ethylene carbonate (EC)/propylene carbonate (PC) (1/1 by weight).

TEOS: Si(OC₂H₅)₄

### General Procedure for Preparing Extruded Material in Semi Closed Device:

A 15 ml twin screw compounder (DSM Xplore) (Miniextruder) was used. All tests were run at 100 rpm. In all tests the residence time was 2 minutes.

### General Procedure for Preparing Films by Compression Molding:

Films were obtained by compression molding using a Collin P 200 T press. The material is heated at 90° C. and pressed at 0 bar for 3 minutes. Then the press is degassed and we set a pressure of 100 bar for 2 minutes still at 90° C. After that the press cools down and it is open at about 30-40° C.

### Determination of Intrinsic Viscosity of Polymer (F)

Intrinsic viscosity (η) [dl/g] was measured using the following equation on the basis of dropping time, at 25° C., of a solution obtained by dissolving the polymer (F) in N, N-dimethylformamide at a concentration of about 0.2 g/dl using a Ubbelhode viscosimeter:

$$[ η ] = \frac{{η}_{sp} + Γ \cdot ln {η}_{r}}{( 1 + Γ ) \cdot c}$$

where c is polymer concentration [g/dl], ηᵣ is the relative viscosity, i.e. the ratio between the dropping time of sample solution and the dropping time of solvent, ηₛₚ is the specific viscosity, i.e. ηᵣ−1, and Γ is an experimental factor, which corresponds to 3 for polymer (F).

### Dissolution Test

A sample of about 5-10 mg o membrane was placed in about 10 ml of N, N-dimethylformamide (DMF) for 60 minutes at room temperature.

DMF is a very good solvent for polymer (F). The more crosslinking density of the membrane, the more swelling and less dissolution of the membrane in DMF is attainable. On the contrary, a poor crosslinked membrane will lead to a mostly dissolution of the membrane in DMF.

### Example 1—Manufacture of a Fluoropolymer Film with F-1 by Solvent Casting (Variant A)

The polymer (F-1) (0.8 g) was dissolved in 7.2 g of acetone at room temperature thereby providing a solution containing 10% by weight of the polymer (F-1). The solution was homogeneous. Then, to this solution were added in the following order: 2.8 g of EL-1, 6.4 mg of ATS, 0.16 g of EPP-1. The solution was mixed for about 10 minutes and 1.38 g of TEOS and 0.76 g of formic acid were added to the solution. Then it was poured into a petri glass of 80×15 mm and let it overnight under the hood at room temperature to evaporate the acetone. Then a film of about 300 microns was obtained and tested in DMF according to the dissolution method and the result was that no dissolution was observed in DMF.

### Example 2—Manufacture of a Fluoropolymer Film with F-2 by Solvent Casting (Variant A)

The same procedure under Example 1 was followed but using F-2 polymer and EPP-2 (same amount of EPP-1 of example 1). Then a film of about 300 microns was obtained and tested in DMF according to the dissolution method and the result was that no dissolution was observed in DMF.

### Comparative Example 1 by Solvent Casting

A film was manufactured following the same procedure under Example 1 but not introducing the EPP-1 and ATS. The film dissolved in DMF in the dissolution test.

### Example 3—Manufacture of a Fluoropolymer Film with F-1 by Processing in the Molten State (Variant B)

The reaction was carried out in a reactor Novoclave by Büchiglasuster having the following characteristics:
Novoclave by Büchiglasuster—Laboratory high pressure/high temperature reactor (HPHT). Reactor volume: 100-600 ml, Pressure: up to 1500 bar, Temperature: −20° C. to +500° C. Electrical heating with built-in automated tap water cooling for fast and precise temperature control and programmable PID controller. The magnetic stirrer drive ensures efficient mixing and stirring of the process media as well as excellent heat transfer. Material: stainless steel.

The following ingredients were fed into the reactor: Polymer (F-1) (9.6 g), EL-1 (33.6 g), ATS (6.4 mg), EPP-1 (0.64 g) and finally an homogeneous solution formed by TEOS (16.56 g), water (5.74 g), ethanol (4.14 g) and citric acid (0.22 g). Then the reactor was brought at 110° C. and kept at that temperature under agitation at 1000 rpm for 24 h. Then the reactor was discharged and the product obtained was grinded and dried for 1 h at 40° C. Part of this material was fed in the miniextruder as above defined above and processed at 90° C. The resulting extruded material was compressed molded in the equipment and conditions described above. Then a film of about 100 microns was obtained and tested in DMF: no dissolution was observed in DMF.

### Example 4—Manufacture of a Fluoropolymer Film with F-2 by Processing in the Molten State

The same procedure under Example 3 was followed but using F-2 polymer and EPP-2 instead of EPP-1. The extrusion in the miniextruder was carried out at 110° C. instead of 90° C. Then a film of about 100 microns was obtained and tested in DMF according to the dissolution method and the result was that no dissolution was observed in DMF.

### Comparative Example 2 by Processing in the Molten State

A film was manufactured following the same procedure under Example 3 but not introducing the EPP-1 and ATS. The film was dissolved in DMF.

### Example 5—Manufacture of a Fluoropolymer Film with F-1 by Processing in the Molten State

The following ingredients were put in the reactor described above: Polymer (F-1) (9.6 g), EL-1 (33.6 g), ATS (6.4 mg), EPP-1 (0.64 g). Then the reactor was brought at 90° C. and kept at that temperature under agitation at 1000 rpm for 30 min. The reactor was then cooled down to 50° C. and the following homogeneous solution was charged formed by TEOS (16.56 g), water (5.74 g), ethanol (4.14 g) and citric acid (0.22 g). Then the reactor was brought again at 110° C. and kept at that temperature under agitation at 1000 rpm for 24 h. Then the reactor was discharged and the product obtained was grinded and dried for 1 h at 40° C. Part of this material was fed in the miniextruder mentioned above and processed at 90° C. The resulting extruded material was compressed moulded in the equipment and conditions described above. Then a film of about 100 microns was obtained and tested in DMF and the result was that no dissolution was observed in DMF.

### Comparative Example 3 by Processing in the Molten State

A film was manufactured following the same procedure under Example 4 but not introducing the EPP-2 and ATS. The film was dissolved in DMF.

### Example 6—Manufacture of a Fluoropolymer (F-j) with F-2 by Processing in the Molten State

The following ingredients were put in the reactor described above: Polymer (F-2) (9.6 g), EL-1 (33.6 g), ATS (6.4 mg), EPP-2 (0.64 g). Then the reactor was brought at 110° C. and kept at that temperature under agitation at 1000 rpm for 4 hours. Then the reactor was discharged and the product obtained was dried for 48 h at 70° C.

### Example 7—Manufacture of a Fluoropolymer Film with F-2 by Processing in the Molten State

The following ingredients were put in the reactor described above: Polymer (F-2) (9.6 g), EL-2 (33.6 g), ATS (6.4 mg), EPP-2 (0.64 g) and finally an homogeneous solution formed by TEOS (16.56 g), water (5.74 g), ethanol (4.14 g) and citric acid (0.22 g). Then the reactor was brought at 110° C. and kept at that temperature under agitation at 1000 rpm for 24 h. Then the reactor was discharged and the product obtained was grinded and dried for 1 h at 40° C. Part of this material was fed in the miniextruder mentioned above and processed at 110° C. The resulting extruded material was compressed moulded in the equipment and conditions described above. Then a film of about 100 microns was obtained and tested in DMF and the result was that no dissolution was observed in DMF.

Since this film contains the metal salt the membrane is ionic conductive by itself.

### Example 8—Manufacture of a Fluoropolymer Film with F-2 by Processing in the Molten State, Followed by Curing Treatment

The following ingredients were fed into the reactor (Novoclave by Büchiglasuster, as described in Example 3): Polymer (F-2) (9.6 g), EL-1 (33.6 g), ATS (6.4 mg), EPP-2 (0.64 g) and finally an homogeneous solution formed by TEOS (16.56 g), water (5.74 g), ethanol (4.14 g) and citric acid (0.22 g). Then the reactor was discharged and the product obtained was grinded and dried for 1 h at 40° C. and then reduced to powder by milling. This step was repeated several times (at least 6 times), in order to have enough material to feed the extruder. A co-rotating twin screw extruder (Leistritz ZSE 18 HP, with a screw diameter D of 18 mm and a screw length of 720 mm (40 D)) was used. The extruder was equipped with a main feeder, a second feeder and a degassing unit. The barrel was composed of eight temperature-controlled zones and a cooled one (at the feeder) that allow to set the desired temperature profile. The molten polymer was allowed to exit from a die, composed of a flat profile of 1 mm thick and 40 mm length. The extrudate was stretched between two cold cylinders of diameter 100 mm and width 100 mm with a gap from 100-500 μm. The extrudate was cooled in air. The temperature profile was set at 110° C. for all the heating zones and the extruder rotation speed was regulated at 250 rpm.

Then a film of about 100-300 microns was obtained.

A sample of the film was subjected to a post treatment, either at 90° C. for 2-5 minutes in a press with 10 MPa of pressure to simulate a heated calandre to obtain a cured extruded film or treated in the microwave at 8 00W for 30 seconds.

The sample of the film with no post treatment (uncured extruded film) dissolved almost completely in DMF, while no dissolution was observed for the cured extruded film. Tensile tests were performed on uncured and cured extruded film (1 cm×4 cm) having gauge length of 20 mm at room temperature with an Instrom 5966 machine equipped with 250 N pneumatic grips. Using a loading cell of 2 kN (error <0.25%), the measurement parameter is a strain rate of 1 mm/min.

Three specimens were used for each formulation and the average values and corresponding standard deviations of Young modulus, failure stress and elongation at break were calculated and reported in Table 1.

TABLE 1

| | Young | Failure | Elongation |
|---|---|---|---|
| | Modulus | Stress | at break |
| | [Mpa] | [Mpa] | [%] |
| Uncured extruded | 15 ± 1 | 0.8 ± 0.1 | 44 ± 6 |
| film | | | |
| Cured extruded film | 27 ± 9 | 4.3 ± 1.9 | 83 ± 18 |

### Example 9—Manufacture of a Fluoropolymer Film with F-2; Alternative Processing in the Molten State

(a) The following ingredients were put into a reactor: EL-1 (20 g), TEOS (16.56 g), water (5.74 g), ethanol (4.14 g) and citric acid (0.22 g). Then the reactor was brought at 110° C. and kept at that temperature under agitation at 1000 rpm for 24 h. Then the reactor was discharged and the product obtained was grinded and dried for 1 h at 40° C.

(b) The following ingredients were put into a miniextruder (as above mentioned DSM Xplore) at 110° C.: EL-1 (10.64 g), ATS (14.2 mg), EPP-2 (1.42 g), Polymer (F-2) (7.09 g). The resulting product was pelletized with VariCut pelletizer (Thermo Fisher Scientific).

(c) The products resulting from step (a) and from step (b) were fed with two different feeders into the single inlet feeder and extruded as done in example 8 detailed above. Then a film of about 100-200 microns was obtained.

A sample of the film was subjected to a post treatment either at 90° C. for 2-5 minutes in a press with 10 MPa of pressure to simulate a heated calandre to obtain a cured extruded film or treated in the microwave at 8 00W for 30 seconds.

The sample of the film with no post treatment (uncured extruded film) dissolved almost completely in DMF, while no dissolution was observed for the cured extruded film. Tensile tests were performed on uncured and cured extruded film (1 cm×4 cm) having gauge length of 20 mm at room temperature with an Instrom 5966 machine equipped with 250 N pneumatic grips. Using a loading cell of 2 kN (error <0.25%), the measurement parameter is a strain rate of 1 mm/min.

Uncured extruded film dissolved almost completely in DMF while no dissolution was observed for cured extruded film.

Tensile tests were performed on uncured and cured extruded film (1 cm×4 cm) as described in Example 8. Average values and standard deviations of Young modulus, failure stress and elongation at break are reported in Table 2.

TABLE 2

| | Young | Failure | Elongation |
|---|---|---|---|
| | Modulus | Stress | at break |
| | [Mpa] | [Mpa] | [%] |
| Uncured extruded | 32 ± 3 | 5.7 ± 0.7 | 18 ± 2 |
| film | | | |
| Cured extruded film | 41 ± 2 | 3.4 ± 0.4 | 11 ± 1 |

### Example 10—Manufacture of a Fluoropolymer Film with F-2 by Alternative Processing in the Molten State

The following ingredients were fed into the miniextruder (as above mentioned DSM Xplore) at 110° C.: EL-1 (13.79 g), ATS (2.6 mg), EPP-2 (0.26 g) and Polymer (F-2) (3.94 g). The resulting product was pelletized with VariCut pelletizer (Thermo Fisher Scientific).

The pelletized intermediate (29.45 g) and the following ingredients were put in the reactor: TEOS (12.56 g), water (4.35 g), ethanol (3.14 g), citric acid (0.17 g). The reactor was brought at 110° C. and kept at that temperature under agitation at 1000 rpm for 6 hours. Then the reactor was discharged and the product obtained was grinded and dried for 1 h at 40° C. This material was used to feed the miniextruder mentioned above and processed at 110° C. The resulting extruded material was compression moulded in the equipment and conditions described above. Then a film of about 100 microns was obtained and tested in DMF. No dissolution was observed.

1. A process for manufacturing a fluoropolymer hybrid organic/inorganic composite [polymer (F-h)], said process comprising the following steps:
(i) providing a composition [composition (C1)] containing a liquid medium [medium (L)] and at least one fluoropolymer [polymer (F)], wherein said polymer (F) comprises:
recurring units derived from at least one fluorinated monomer [monomer (FM)], and
recurring units derived from at least one monomer [monomer (FPM)], said monomer (FPM) comprising at least one functional group [group (FX)] selected from the group consisting of: hydroxyl group, amine, carboxylic, thiol and anhydride;
(ii) contacting composition (C1) with at least a first metal compound [compound (M1)] of formula (I):
X₄₋ₘAYₘ (I)
wherein m is an integer from 1 to 3, A is a metal selected from the group consisting of Si, Ti and Zr, each occurrence of Y is a hydrolysable group and each occurrence of X is a hydrocarbon group, wherein at least one X comprises at least one epoxy functional group,
so that at least a fraction of the group (FX) of monomer (FPM) of polymer (F) is reacted with at least a fraction of compound (M1), thereby providing a composition [composition (C2)] comprising at least one grafted fluoropolymer [polymer (F-j)] bearing -AYₘ pendant groups;
(iii) contacting composition (C2) with at least a second metal compound [compound (M2)], different from the compound (M1), of formula (II):
X′_{4-m′}A′Y′_{m′} (II)
wherein m′ is an integer from 1 to 4, A′ is a metal selected from the group consisting of Si, Ti and Zr, each occurrence of Y′ is a hydrolysable group and each occurrence of X′ is a hydrocarbon group, optionally comprising at least one functional group [group (FX′)], different from group (FX), so that at least a fraction of compound (M2) is reacted with at least a fraction of the -AYₘ pendant groups of polymer (F-j), thereby providing a composition [composition (C3)] comprising at least one grafted fluoropolymer [polymer (F-g)] bearing -A′Y′ₘ pendant groups; and
(iv) hydrolysing and/or condensing the -A′Y′ₘ pendant groups of polymer (F-g) thereby providing a composition [composition (C4)] comprising at least one fluoropolymer hybrid organic/inorganic composite [polymer (F-h)].

2. The process according to claim 1, wherein monomer (FPM) is an hydrogenated monomer of formula (III): 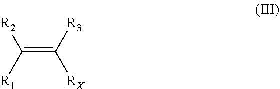
wherein:
R₁, R₂ and R₃, equal to or different from each other, are independently selected from a hydrogen atom and a C₁-C₃ hydrocarbon group, and
R_{X} is a C₁-C₂₀ hydrocarbon moiety comprising at least one functional group [group (FX)] selected from the group consisting of: hydroxyl group, amine, carboxylic acid group, thiol group and anhydride.

3. The process according to claim 2, wherein monomer (FPM) is selected from the group consisting of (meth)acrylic monomers of formula (IV): 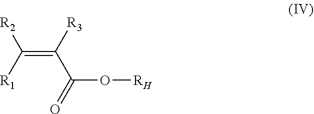
wherein R1, R2 and R3, equal to or different from each other, are independently selected from a hydrogen atom and a C1-C3 hydrocarbon group, RH is a hydrogen atom or a C1-C20 hydrocarbon moiety comprising at least one functional group [group (FXH)] selected from the group consisting of:
hydroxyl group, amine, carboxylic group, thiol group and anhydride.

4. The process according to claim 3, wherein monomer (FPM) is selected from the group consisting of hydroxyethyl(meth)acrylate, hydroxypropyl(meth)acrylate, hydroxyethylhexyl(meth)acrylate, acrylic acid (AA) and succinic acid 1-[2-(acryloyloxy)propyl] ester.

5. The process according to claim 1, wherein monomer (FM) is selected from the group consisting of vinylidene fluoride (VDF), tetrafluoroethylene (TFE) and chlorotrifluoroethylene (CTFE).

6. The process according to claim 1, wherein polymer (F) is semi-crystalline and has intrinsic viscosity, measured in dimethylformamide at 25° C., comprised between 0.05 l/g and 0.80 l/g.

7. The process according to claim 1, wherein medium (L) is selected from organic carbonates, ionic liquids (IL), solvents(S), or mixtures thereof.

8. The process according to claim 7, wherein solvent(S) is selected from the group consisting of: N-methyl-2-pyrrolidone (NMP), N,N-dimethylformamide, N,N-dimethylacetamide, dimethylsulfoxide, hexamethylphosphamide, dioxane, tetrahydrofuran, tetramethylurea, triethyl phosphate, and trimethyl phosphate, aliphatic ketones, cycloaliphatic ketones, cycloaliphatic esters.

9. The process according to claim 1, wherein polymer (F) comprises:
(a) at least 60% by moles of vinylidene fluoride (VDF);
(b) optionally, from 0.1% to 15% by moles of at least one monomer (FM) selected from vinyl fluoride (VF1), chlorotrifluoroethylene (CTFE), hexafluoropropylene (HFP), tetrafluoroethylene (TFE), trifluoroethylene (TrFE), perfluoromethylvinylether (PMVE); and
and
(c) from 0.01% to 10% by moles of acrylic acid (AA),
said polymer (F) having intrinsic viscosity, measured in dimethylformamide at 25° C., that is comprised between 0.2 l/g and 0.4 l/g.

10. A fluoropolymer hybrid organic/inorganic composite [polymer (F-h)] obtained by the process according to claim 1.

11. A grafted fluoropolymer [polymer (F-j)], obtained by a process comprising the following steps:
(i) providing a composition [composition (C1)] containing a liquid medium [medium (L)] and at least one fluoropolymer [polymer (F)], wherein said polymer (F) comprises:
recurring units derived from at least one fluorinated monomer [monomer (FM)], and
recurring units derived from at least one monomer [monomer (FPM)], said monomer (FPM) comprising at least one functional group [group (FX)] selected from the group consisting of: hydroxyl group, amine, carboxylic, thiol and anhydride;
(ii) contacting composition (C1) with at least a first metal compound [compound (M1)] of formula (I):
X₄₋ₘAYₘ (I)
wherein m is an integer from 1 to 3, A is a metal selected from the group consisting of Si, Ti and Zr, each occurrence of Y is a hydrolysable group and each occurrence of X is a hydrocarbon group, wherein at least one X comprises at least one epoxy functional group,
so that at least a fraction of the group (FX) of monomer (FPM) of polymer (F) is reacted with at least a fraction of compound (M1), thereby providing a composition [composition (C2)] comprising at least one grafted fluoropolymer [polymer (F-j)] bearing -AYₘ pendant groups; and
(iib) isolating the fluoropolymer [polymer (F-j)] as solid by filtration of composition (C2), washing the solid with polar solvents and drying to recover dry polymer (F-j).

12. A fluoropolymer film comprising at least one fluoropolymer hybrid organic/inorganic composite [polymer (F-h)] according to claim 11.

13. The fluoropolymer film according to claim 12 that has a thickness in the range from 5 to 300 microns.

14. A process for the manufacture of a fluoropolymer film comprising at least one fluoropolymer hybrid organic/inorganic composite [polymer (F-h)] according to claim 12, said process comprising the following steps:
(i) providing a composition [composition (C1)] containing a liquid medium [medium (L)] and at least one fluoropolymer [polymer (F)], wherein said polymer (F) comprises:
recurring units derived from at least one fluorinated monomer [monomer (FM)], and
recurring units derived from at least one monomer [monomer (FPM)], said monomer (FPM) comprising at least one functional group [group (FX)] selected from the group consisting of: hydroxyl group, amine, carboxylic, thiol and anhydride; and
(ii) contacting composition (C1) with at least a first metal compound [compound (M1)] of formula (I):
X₄₋ₘAYₘ (I)
wherein m is an integer from 1 to 3, A is a metal selected from the group consisting of Si, Ti and Zr, each occurrence of Y is a hydrolysable group and each occurrence of X is a hydrocarbon group, wherein at least one X comprises at least one epoxy functional group,
so that at least a fraction of the group (FX) of monomer (FPM) of polymer (F) is reacted with at least a fraction of compound (M1), thereby providing a composition [composition (C2)] comprising at least one grafted fluoropolymer [polymer (F-j)] bearing -AYₘ pendant groups; and
(iii) contacting composition (C2) with at least a second metal compound [compound (M2)], different from the compound (M1), of formula (II):
X′_{4-m′}A′Y′_{m′} (II)
wherein m′ is an integer from 1 to 4, A′ is a metal selected from the group consisting of Si, Ti and Zr, each occurrence of Y′ is a hydrolysable group and each occurrence of X′ is a hydrocarbon group, optionally comprising at least one functional group [group (FX′)], different from group (FX), so that at least a fraction of compound (M2) is reacted with at least a fraction of the -AYₘ pendant groups of polymer (F-j), thereby providing a composition [composition (C3)] comprising at least one grafted fluoropolymer [polymer (F-g)] bearing -A′Y′ₘ pendant groups; and
(iv) hydrolysing and/or condensing the -A′Y′ₘ pendant groups of polymer (F-g) thereby providing a composition [composition (C4)] comprising at least one fluoropolymer hybrid organic/inorganic composite [polymer (F-h)].
(v) processing composition (C4) comprising at least one fluoropolymer hybrid organic/inorganic composite [polymer (F-h)] obtained in step (iv), into a film; and
(vi) drying the film provided in step v).

15. A process for manufacturing a polymer electrolyte membrane, said process comprising:
(i) providing a composition [composition (C5)] containing a liquid medium [medium (L)] and at least one fluoropolymer [polymer (F)], wherein said polymer (F) comprises:
recurring units derived from at least one fluorinated monomer [monomer (FM)], and
recurring units derived from at least one monomer [monomer (FPM)], said monomer (FPM) comprising at least one functional group [group (FX)] selected from the group consisting of: hydroxyl group, amine, carboxylic, thiol and anhydride,
wherein the liquid medium (L) also comprises at least one metal salt(S); and
(ii) contacting composition (C5) with at least a first metal compound [compound (M1)] of formula (I):
X₄₋ₘAYₘ (I)
wherein m is an integer from 1 to 3, A is a metal selected from the group consisting of Si, Ti and Zr, each occurrence of Y is a hydrolysable group and each occurrence of X is a hydrocarbon group, wherein at least one X comprises at least one epoxy functional group,
so that at least a fraction of the group (FX) of monomer (FPM) of polymer (F) is reacted with at least a fraction of compound (M1), thereby providing a composition [composition (C2′)] comprising at least one grafted fluoropolymer [polymer (F-j)] bearing -AYₘ pendant groups; and
(iii) contacting composition (C2′) with at least a second metal compound [compound (M2)], different from the compound (M1), of formula (II):
X′_{4-m′}A′Y′_{m′} (II)
wherein m′ is an integer from 1 to 4, A′ is a metal selected from the group consisting of Si, Ti and Zr, each occurrence of Y′ is a hydrolysable group and each occurrence of X′ is a hydrocarbon group, optionally comprising at least one functional group [group (FX′)], different from group (FX), so that at least a fraction of compound (M2) is reacted with at least a fraction of the -AYₘ pendant groups of polymer (F-j),) thereby providing a composition [composition (C3′)] comprising at least one grafted fluoropolymer [polymer (F-g)] bearing -A′Y′ₘ pendant groups;
(iv) hydrolysing and/or condensing the -A′Y′ₘ pendant groups of polymer (F-g) thereby providing a composition [composition (C4′)] comprising at least one fluoropolymer hybrid organic/inorganic composite [polymer (F-h)];
(v) processing composition (C4′) into a film; and
(vi) drying the film provided in step (v).

16. An electrochemical device comprising the polymer electrolyte membrane according to claim 15.
